(19) United States
(12) Patent Application Publication
(10) Pub. No.: US 2025/0336579 A1
(43) Pub. Date: Oct. 30, 2025

(54) Composition for Preparing Bonded Magnets, Bonded Magnet, and Preparation Method

(71) Applicant: BEIJING ZHONG KE SAN HUAN HI-TECH CO., LTD., Beijing (CN)

(72) Inventors: Shulei CHEN, Beijing (CN); Shuai WANG, Beijing (CN); Congcong WANG, Beijing (CN); Guochao QIN, Beijing (CN); Daoyan CAI, Beijing (CN); Zhan WANG, Beijing (CN)

(21) Appl. No.: 19/170,172

(22) Filed: Apr. 4, 2025

(30) Foreign Application Priority Data
Apr. 24, 2024 (CN) 202410500804.1

(51) Int. Cl. H01F 1/08; H01F 41/02

(52) U.S. Cl. CPC H01F 1/083; H01F 41/0266

(57) ABSTRACT

A bonded magnet, a composition for preparing bonded magnets, and a method for preparing adhesive magnets using the composition. The bonded magnet includes magnetic powder and a binder. The binder includes a vitrimer. A content of the magnetic powder ranges from 96 wt % to 98 wt % and a content of the binder ranges from 0.89 wt % to 2.17 wt %. The composition includes magnetic powder, a polymer precursor, a crosslinking agent, and a catalyst capable of catalyzing a crosslinking reaction between the crosslinking agent and the polymer precursor to form a dynamically crosslinked network structure.

### CROSS-REFERENCE TO RELATED APPLICATION

This application claims priority to Chinese Application No. 202410500804.1, filed on Apr. 24, 2024, the entire content of which is incorporated herein by reference.

### TECHNICAL FIELD

The present disclosure relates to the field of bonded magnets and, in particular, to a composition for preparing bonded magnets, the bonded magnet, and its preparation method.

### BACKGROUND

Due to the scarcity of rare earth resources, the recyclability of rare-earth magnets has become increasingly critical. The bonded magnets prepared with thermosetting resins as binders are currently widely used rare earth bonded magnets. For example, using epoxy resins as binders to prepare compression magnets, with high magnetic powder filling ratio, high product strength, good high temperature stability of magnets, simple preparation process. However, since thermosetting resins are one-time forming, it is difficult to recycle and reuse after crosslinking. On the other hand, the compression magnets prepared with thermoplastic resins as binders can be recycled and reprocessed, but due to the low thermal deformation temperature of thermoplastic resins, the stability is poor during compression molding at high temperatures, and they are rarely used in practice.

### SUMMARY

The present disclosure aims to provide a composition for preparing bonded magnets, bonded magnets themselves, and methods for their preparation and recycling. The bonded magnets produced by the method disclosed herein exhibit excellent recyclability. After undergoing crushing and recycling, these magnets retain high magnetic and mechanical properties.

The first aspect of the disclosure provides a bonded magnet, which comprises magnetic powder and a binder comprising a vitrimer, wherein the magnetic powder content ranging from 96 to 98 wt % and the binder content ranging from 0.89 to 2.17 wt %.

In some embodiments, the vitrimer is a temperature-responsive vitrimer with a dynamic crosslinking temperature ranging from 85 to 177° C., and the linear thermal expansion coefficient of the bonded magnet increasing with temperature above the dynamic crosslinking temperature.

In some embodiments, the vitrimer is selected from the group consisting of: ester-exchange vitrimers, ether-exchange vitrimers, alkylation-dealkylation vitrimers, transcarbonation vitrimers, hydroxy-urethane bond-exchange vitrimers, urethane-urethane bond-exchange vitrimers, disulfide bond-exchange vitrimers, silanol-exchange vitrimers, olefin metathesis vitrimers, imine-exchange vitrimers, and acylhydrazone bond-exchange vitrimers, or combinations thereof.

In some embodiments, a polymer precursor of the vitrimer is selected from thermosetting resins, thermoplastic resins, thermoplastic elastomers, and rubbers, or combinations thereof.

In some embodiments, the polymer precursor is selected from the group consisting of: polyimide, polyamide, polyester, polyether, polyoxymethylene, polycarbonate, polymethyl methacrylate, polyethyl methacrylate, polybutyl methacrylate, polybutylene terephthalate, polystyrene, poly(4-vinylpyridine), polylactic acid, chitosan, cellulose and derivatives thereof, polyurethane, thermoplastic polyester elastomer, acrylate copolymer, epoxy resin, phenolic resin, urea-formaldehyde resin, polyvinyl alcohol, polyvinyl butyral, polyvinyl acetate, polyether ether ketone, natural rubber, nitrile rubber, butyl rubber, ethylene-propylene rubber, ethylene-propylene-diene rubber, cis-polybutadiene rubber, silicone rubber, fluororubber, ethylene-vinyl acetate copolymer, acrylonitrile-butadiene-styrene copolymer, and styrene-butadiene-styrene copolymer, or combinations thereof.

In some embodiments, the magnetic powder is selected from the group consisting of: NdFeB magnetic powder, SmFeN magnetic powder, NdFeN magnetic powder, SmCo magnetic powder, ferrite powder, AlNiCo magnetic powder, FeCo magnetic powder, FeSiAl magnetic powder, and FeSi magnetic powder. the magnetic powder is selected from NdFeB, SmFeN, NdFeN, SmCo, ferrite, AlNiCo, FeCo, FeSiAl, and FeSi magnetic powders.

The second aspect of the present disclosure provides a composition for preparing bonded magnets, which includes magnetic powder, a polymer precursor, a crosslinking agent, and a catalyst capable of catalyzing a crosslinking reaction between the crosslinking agent and the polymer precursor to form a dynamically crosslinked network structure.

In some embodiments, the magnetic powder is selected from the group consisting of: NdFeB magnetic powder, SmFeN magnetic powder, NdFeN magnetic powder, SmCo magnetic powder, ferrite powder, AlNiCo magnetic powder, FeCo magnetic powder, FeSiAl magnetic powder, and FeSi magnetic powder, with the particle size ranging from 2 to 150 μm;
the polymer precursor is selected from the group consisting of: polyimide, polyamide, polyester, polyether, polyoxymethylene, polycarbonate, polymethyl methacrylate, polyethyl methacrylate, polybutyl methacrylate, polybutylene terephthalate, polystyrene, poly(4-vinylpyridine), polylactic acid, chitosan, cellulose and derivatives thereof, polyurethane, thermoplastic polyester elastomer, acrylate copolymer, epoxy resin, phenolic resin, urea-formaldehyde resin, polyvinyl alcohol, polyvinyl butyral, polyvinyl acetate, polyether ether ketone, natural rubber, nitrile rubber, butyl rubber, ethylene-propylene rubber, ethylene-propylene-diene rubber, cis-polybutadiene rubber, silicone rubber, fluororubber, ethylene-vinyl acetate copolymer, acrylonitrile-butadiene-styrene copolymer, and styrene-butadiene-styrene copolymer, or combinations thereof;
the crosslinking agent is selected from multifunctional halogenated hydrocarbons or active hydrogen-containing compounds, in some embodiments, the crosslinking agent selected from one or more of dihalogenated hydrocarbons, polyhalogenated hydrocarbons, diethylamine, triethylamine, polyamines, 1,4-butanediol, isopentyl glycol, pentaerythritol, glycerol, polyols, diphenols, polyphenols, dithiols, polythiols, amides, diureas, polyureas, diisocyanates, polyisocyanates, maleic anhydride derivatives, phthalate derivatives, oxalic acid, diacids, polyacids, polytetrahydrofuran, polyethylene glycol, polyvinyl alcohol, macromolecular diols, telechelic polyols, linear telechelic polymers with hydroxyl, thiol, amino, carboxyl, epoxy, formate, or acetate groups, star polymers, and hyperbranched polymers;
the catalyst is selected from organic zinc salts, in some embodiments, zinc acetate, 1,5,7-triazabicyclo[4.4.0]dec-5-ene, triphenylphosphine, or stannous octoate, or combinations thereof; and
the composition contains 96 to 98 wt % magnetic powder, 0.88 to 2.17 wt % polymer precursor, 0.22 to 0.55 wt % crosslinking agent, and 0.3 to 0.5 wt % catalyst.

In some embodiments, the composition further include a coupling agent and a release agent, wherein:
the coupling agent selected from silane coupling agents, titanate coupling agents, aluminate coupling agents, phosphate coupling agents, or organoiron coupling agents;
the release agent selected from silicone-based agents, fluorine-based agents, natural waxes, synthetic waxes, molybdenum disulfide, fatty waxes, or polyester films; and
the composition contains 0.28-0.30 wt % coupling agent and 0.30-0.50 wt % release agent.

The third aspect of the present disclosure provides a method for preparing a bonded magnet using the composition described in the second aspect of the disclosure, which comprises:
mixing magnetic powder, polymer precursor, crosslinking agent, and catalyst to obtain a particle mixture;
forming the particle mixture into a compact, followed by curing the compact.

In some embodiments, the method further includes: adding a solvent during the mixing process and stirring, while heating to remove the solvent during the stirring process, resulting in the particle mixture; the heating temperature being 10 to 50° C. higher than the boiling point of the solvent, in some embodiments, 10 to 20° C. higher, for a duration of 3 to 4 hours;
wherein the solvent is selected from one or more of deionized water, methanol, ethanol, isopropanol, n-butanol, isobutanol, tert-pentanol, ethyl ether, acetone, methyl ethyl ketone, diethyl ketone, methyl isobutyl ketone, tetrahydrofuran, chloroform, n-pentane, cyclopentane, cyclohexane, n-hexane, n-heptane, n-octane, N,N-dimethylformamide, N,N-dimethylacetamide, pyridine, benzene, toluene, xylene, isobutyl acetate, n-butyl acetate, sec-butyl acetate, ethyl acetate, isopropyl acetate, and n-propyl acetate.

In some embodiments, the method further includes:
under heating conditions, introducing the magnetic powder, polymer precursor, crosslinking agent, and catalyst into a two-roll mill for mixing, resulting in the particle mixture;
wherein the surface of the rolls of the two-roll mill is provided with grooves or protrusions.

In some embodiments, the method also includes:
pretreating the magnetic powder with a coupling agent prior to the mixing process to obtain a particle mixture, the particle mixture further includes a release agent;
in the forming compact process, which employs compression molding or rolling molding, wherein the pressure during the forming process is 5 to 10 MPa and the temperature is 25 to 100° C.;
in the cuing the compact process, wherein the curing treatment is conducted at a temperature of 80 to 200° C. for a duration of 2 to 24 hours.

The fourth aspect of the present disclosure provides a bonded magnet prepared by the method described in the third aspect of the disclosure.

The fifth aspect of the present disclosure provides a method for regenerating a bonded magnet, wherein the method comprises:
subjecting the dynamic covalent bonds within the bonded magnet to chain decomposition at a temperature between 85° C. and 177° C., followed by a re-crosslinking thermoreversible reaction to obtain a regenerated bonded magnet.

Through the aforementioned technical proposal, the present disclosure employs a polymer system capable of forming a dynamic covalent crosslinked network as the binder for the bonded magnet. This results in a bonded magnet having a dynamic crosslinked network structure, wherein exchangeable dynamic covalent bonds formed within the magnet can undergo crosslinking-depolymerization-recrosslinking dynamic crosslinking reactions under specific conditions. This allows the surfaces of the magnet to adhere to each other after fragmentation, thus enabling the re-molding of the magnet and yielding a regenerated bonded magnet. Therefore, the bonded magnet provided by the present disclosure possesses an extremely high recyclability, exhibits reversible processability without melting, and retains a significant portion of its original molding density even after multiple fragmentation and re-molding processes, maintaining high magnetic and mechanical properties.

Furthermore, the present disclosure utilizes solution blending or melt blending methods, effectively mixing high-fill-ratio magnetic powder with the binder. In solution blending, a solvent is added, and during stirring, the solvent is heated and removed, allowing the viscosity of the particle mixture to be effectively reduced during the rapid removal of the solvent. This enhances the flowability of the high-fill-ratio magnetic powder and facilitates a uniform mixture with a high molecular weight binder. In melt blending, a two-roll mill with grooves or protrusions on the rolls is employed to mix the magnetic powder and binder at high temperatures, ensuring thorough blending of the high-fill-ratio magnetic powder with insoluble high molecular weight binders such as rubber.

Other features and advantages of the present disclosure will be described in detail in the following specific embodiment section.

### BRIEF DESCRIPTION OF DRAWINGS

The figures included in this disclosure are provided to enhance the understanding of the present disclosure. The illustrative embodiments and their descriptions herein are intended to elucidate the present disclosure and do not impose any undue limitations thereon.

FIG. 1 illustrates the thermal deformation behavior of the bonded magnet prepared in Example 1 of the present disclosure compared to the bonded magnet prepared in Comparative Example 1.

FIG. 2 illustrates the thermal deformation behavior of the bonded magnet prepared in Example 12 of the present disclosure compared to the bonded magnet prepared in Comparative Example 1.

FIG. 3 is a schematic representation of the shape of the raised structures on the surfaces of the rolls in the open mill used in Example 12 of the present disclosure.

FIG. 4 is a schematic representation of the shape of the raised structures on the surfaces of the rolls in the open mill used in another embodiment of the present disclosure.

FIG. 5 is a schematic representation of the shape of the raised structures on the surfaces of the rolls in the open mill used in yet another embodiment of the present disclosure.

### DETAILED DESCRIPTION OF EMBODIMENTS

The following detailed description of specific embodiments of the present disclosure is made in conjunction with the accompanying drawings. It should be understood that the specific embodiments described herein are for illustrative and explanatory purposes only and are not intended to limit the scope of the present disclosure.

The first aspect of the disclosure provides a bonded magnet, which comprises magnetic powder and a binder comprising a vitrimer, wherein the magnetic powder content ranging from 96 to 98 wt % and the binder content ranging from 0.89 to 2.17 wt %.

The bonded magnet provided by the present disclosure contains a vitrimer material, which is a vitrimer that imparts a dynamic crosslinked network structure to the bonded magnet. The exchangeable dynamic covalent bonds formed within this structure can undergo dynamic crosslinking-depolymerization-recrosslinking reactions under specific conditions, allowing the surfaces of the magnet to adhere to one another after fragmentation, thereby enabling the re-molding of the magnet to obtain a regenerated bonded magnet. Consequently, the bonded magnet provided by the present disclosure exhibits a remarkably high recyclability, and even after multiple cycles of fragmentation and re-molding, it maintains a significant portion of the original molding density, along with high magnetic and mechanical properties.

In some embodiments, the density of the bonded magnet ranges from 3.9 to 7.0 g/cm³, the residual magnetism is between 3100 to 7800 Gs, the intrinsic coercivity is from 2500 to 12000 Oe, and the maximum magnetic energy product is between 1.92 to 13.55 MGOe.

In a specific embodiment, the vitrimer is a temperature-responsive vitrimer; the dynamic crosslinking temperature of the vitrimer ranges from 85 to 177° C.; the linear thermal expansion coefficient of the bonded magnet above the dynamic crosslinking temperature increases with rising temperature. In this embodiment, when an appropriate stimulus is applied to the magnet, such as maintaining the magnet at a specific temperature, the dynamic covalent bonds within the temperature-responsive vitrimer will undergo dynamic exchange, specifically the depolymerization-recrosslinking dynamic crosslinking reaction, leading to a topological rearrangement of the crosslinked network. This endows the magnet provided by the present disclosure with extremely high recyclability, allowing for processing and re-molding at specific temperatures, and retaining high magnetic and mechanical properties even after multiple cycles of fragmentation and re-molding.

In other embodiments of the present disclosure, the vitrimer is selected from one or more of the following: light-responsive vitrimers, pH-responsive vitrimers, solvent-responsive vitrimers, and humidity-responsive vitrimers.

In a specific embodiment, the vitrimer is selected from the group consisting of: ester-exchange vitrimers, ether-exchange vitrimers, alkylation-dealkylation vitrimers, transcarbonation vitrimers, hydroxy-urethane bond-exchange vitrimers, urethane-urethane bond-exchange vitrimers, disulfide bond-exchange vitrimers, silanol-exchange vitrimers, olefin metathesis vitrimers, imine-exchange vitrimers, and acylhydrazone bond-exchange vitrimers, or combinations thereof;

wherein the ester-exchange vitrimers refer to a type of vitrimers that can undergo dynamic crosslinking through an ester exchange reaction at the dynamic crosslinking temperature; the meanings of the other types of vitrimers are similar and will not be elaborated upon further herein.

In a further embodiment, the reaction process of the ester-exchange vitrimers undergoing dynamic crosslinking is illustrated in Equation (1):

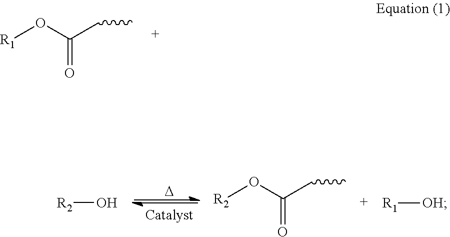

the reaction process of the epoxy vitrimers undergoing an ester exchange reaction is illustrated in Equation (2):

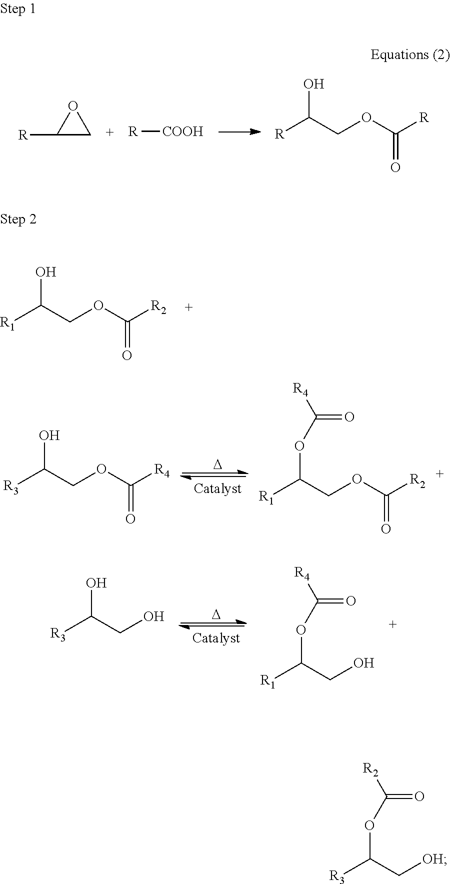

the reaction process of the ether-exchange vitrimers undergoing dynamic crosslinking is illustrated in Equation (3):

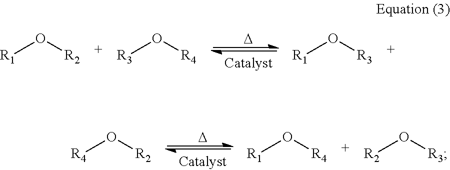

the reaction process of the alkylation-dealkylation vitrimers undergoing dynamic crosslinking is illustrated in Equation (4):

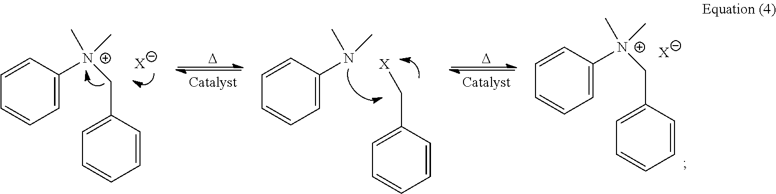

the reaction process of the transcarbonation vitrimers undergoing dynamic crosslinking is illustrated in Equation (5):

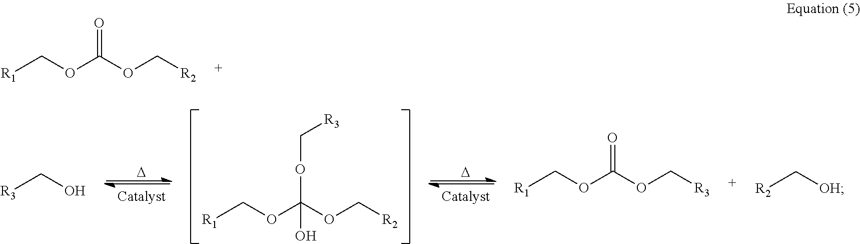

the reaction process of the hydroxy-urethane bond-exchange vitrimers undergoing dynamic crosslinking is illustrated in Equation (6):

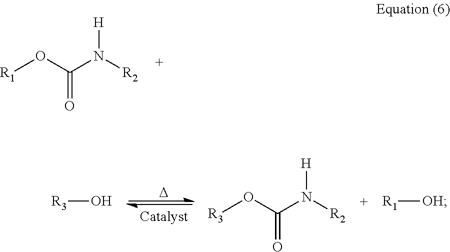

the reaction process of the urethane-urethane bond-exchange vitrimers undergoing dynamic crosslinking is illustrated in Equation (7):

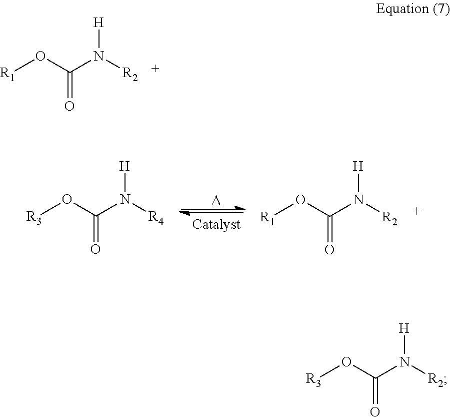

the reaction process of the disulfide bond-exchange vitrimers undergoing dynamic crosslinking is illustrated in Equation (8):

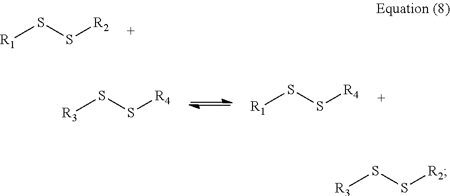

the reaction process of the silanol-exchange vitrimers undergoing dynamic crosslinking is illustrated in Equation (9):

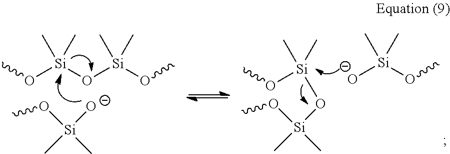

the reaction process of the olefin metathesis vitrimers undergoing dynamic crosslinking is illustrated in Equation (10):

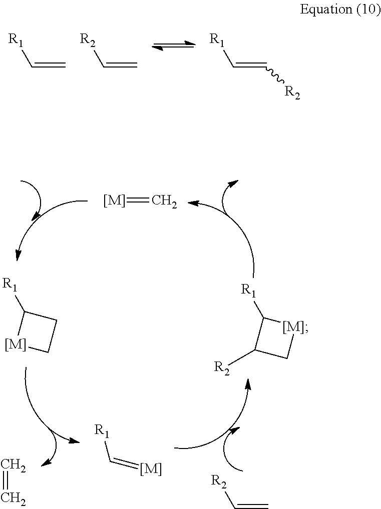

the reaction process of the imine-exchange vitrimers undergoing dynamic crosslinking is illustrated in Equation (11):

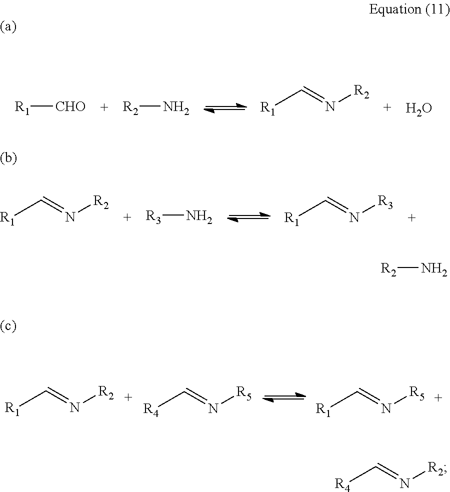

the reaction process of the acylhydrazone bond-exchange vitrimers undergoing dynamic crosslinking is illustrated in Equation (12):

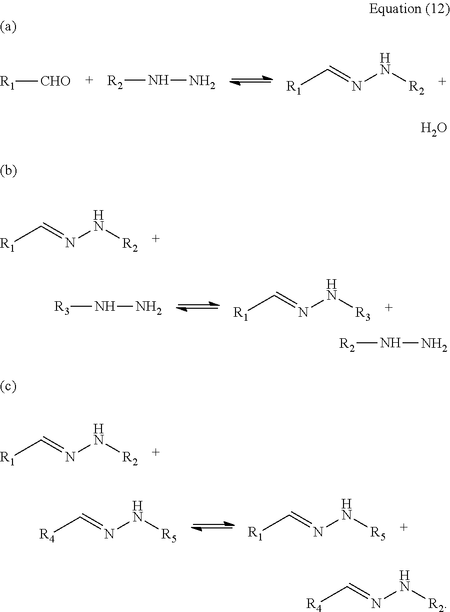

It is understood that the aforementioned reaction processes are exemplary and do not limit the vitrimers. In a specific embodiment, the polymer precursors of the vitrimer are selected from one or more of the following: thermosetting resins, thermoplastic resins, thermoplastic elastomers, and rubbers.

In a further embodiment, the polymer precursors are selected from polyimides, polyamides, polyesters, polyethers, polyformaldehyde, polycarbonates, polymethyl methacrylate, polyethyl methacrylate, polybutyl methacrylate, poly(butylene terephthalate), polystyrene, poly(4-vinylpyridine), polylactic acid, chitosan, cellulose and its derivatives, polyurethanes, thermoplastic polyester elastomers, acrylate copolymers, epoxy resins, phenolic resins, urea-formaldehyde resins, polyvinyl alcohol, polyvinyl butyral, polyvinyl acetate, polyether ether ketone, natural rubber, nitrile rubber, butyl rubber, ethylene-propylene rubber, terpolymer ethylene-propylene rubber, cis-butadiene rubber, silicone rubber, fluororubber, ethylene-vinyl acetate copolymers, acrylonitrile-butadiene-styrene copolymers, and styrene-butadiene-styrene copolymers.

In some embodiments, the polymer precursors are selected from one or more of epoxy resins, phenolic resins, polymethyl methacrylate, poly(butylene terephthalate), polycarbonates, polyamides, poly(4-vinylpyridine), polyurethanes, thermoplastic polyester elastomers, nitrile rubber, and terpolymer ethylene-propylene rubber. Using polymer precursors in the aforementioned embodiments can further enhance the mechanical properties, such as tensile strength and flexural strength, of the prepared magnets and provide better processability for the magnets.

In one specific embodiment, the magnetic powder is selected from the group consisting of: NdFeB magnetic powder, SmFeN magnetic powder, NdFeN magnetic powder, SmCo magnetic powder, ferrite powder, AlNiCo magnetic powder, FeCo magnetic powder, FeSiAl magnetic powder, and FeSi magnetic powder. In some embodiments, the magnetic powder is selected from the group consisting of: NdFeB magnetic powder, SmFeN magnetic powder, NdFeN magnetic powder, ferrite powder, and SmCo magnetic powder.

The second aspect of the present disclosure provides a composition for preparing bonded magnets, wherein the composition comprises magnetic powder, polymer precursors, crosslinking agents, and catalysts; the catalyst is capable of catalyzing the crosslinking reaction between the crosslinking agent and the polymer precursor, resulting in the formation of a dynamic crosslinked network structure.

In the composition provided by the present disclosure, under catalytic conditions, the crosslinking agent can undergo a crosslinking curing reaction with the polymer precursor, which, on one hand, forms a molecular network structure that enhances the mechanical properties of the prepared magnets; on the other hand, provides a dynamic crosslinked structure for the bonded magnets, allowing the magnets to undergo crosslinking-dechain-recrosslinking thermoreversible reactions under specific conditions, thereby ensuring excellent magnetic and mechanical properties while providing outstanding regeneration capability.

In one specific embodiment, the magnetic powder is selected from NdFeB magnetic powder, SmFeN magnetic powder, NdFeN magnetic powder, SmCo magnetic powder, ferrite powder, AlNiCo magnetic powder, FeCo magnetic powder, FeSiAl magnetic powder, and FeSi magnetic powder, and in some embodiments the magnetic powder is selected from NdFeB magnetic powder, SmFeN magnetic powder, NdFeN magnetic powder, ferrite powder, and SmCo magnetic powder.

In further embodiments, the particle size of the magnetic powder is in the range of 2 to 150 μm, in some embodiments, 40 to 70 μm. The selection of magnetic powder within this particle size range for preparing bonded magnets can further enhance the density and maximum magnetic energy product of the prepared bonded magnets.

The polymer precursor is selected from the group consisting of: polyimide, polyamide, polyester, polyether, polyoxymethylene, polycarbonate, polymethyl methacrylate, polyethyl methacrylate, polybutyl methacrylate, polybutylene terephthalate, polystyrene, poly(4-vinylpyridine), polylactic acid, chitosan, cellulose and derivatives thereof, polyurethane, thermoplastic polyester elastomer, acrylate copolymer, epoxy resin, phenolic resin, urea-formaldehyde resin, polyvinyl alcohol, polyvinyl butyral, polyvinyl acetate, polyether ether ketone, natural rubber, nitrile rubber, butyl rubber, ethylene-propylene rubber, ethylene-propylene-diene rubber, cis-polybutadiene rubber, silicone rubber, fluororubber, ethylene-vinyl acetate copolymer, acrylonitrile-butadiene-styrene copolymer, and styrene-butadiene-styrene copolymer, or combinations thereof.

In some embodiments, the polymer precursor is selected from one or more of epoxy resin, phenolic resin, polymethyl methacrylate, polybutylene terephthalate, polycarbonate, polyamide, poly(4-vinylpyridine), polyurethane, thermoplastic polyester elastomers, nitrile rubber, and ternary ethylene-propylene rubber. By using the above types of polymer precursors, the present disclosure can further enhance the tensile strength and flexural strength of the prepared magnets, as well as provide superior processability for the magnets.

In one specific embodiment, the crosslinking agent is selected from multifunctional halogenated hydrocarbons or compounds containing active hydrogen; in some embodiments, the crosslinking agent is selected from one or more of dibrominated hydrocarbons, polyhalogenated hydrocarbons, diethylamine, triethylamine, polyamines and their derivatives, 1,4-butanediol, isoprene glycol, pentaerythritol, glycerol, polyols and their derivatives, binary phenols, polyphenols, binary thiols, polythiols, amides, binary ureas, polyureas, binary isocyanates, polyisocyanates, maleic anhydride and its derivatives, phthalate esters and their derivatives, oxalic acid, binary acids, polyacids and their derivatives, polytetrahydrofuran, polyethylene glycol, polyvinyl alcohol, macromolecular diols, dendritic polyols containing hydroxyl, thiol, amino, carboxyl, epoxy, formate, or acetate functional groups, linear dendritic polymers, star-shaped polymers, and hyperbranched polymers. More in some embodiments, the crosslinking agent is selected from one or more of glycerol, polyvinyl alcohol, diethylamine, triethylamine, pentaerythritol, and 1,4-dibromobutane. By using the above types of crosslinking agents, the present disclosure can further increase the functional groups within the magnets, allowing for a more complete dynamic crosslinking reaction, thereby providing the magnets with superior recyclability.

In one specific embodiment, the catalyst is selected from one or more of organic zinc salts; in some embodiments, the catalyst is selected from one or more of zinc acetate, triazabicyclodecene, triphenylphosphine, and stannous octanoate.

In one specific embodiment, the content of the magnetic powder in the composition is 96 to 98 wt %, the content of the polymer precursor is 0.88 to 2.17 wt %, the content of the crosslinking agent is 0.22 to 0.55 wt %, and the content of the catalyst is 0.3 to 0.5 wt %.

In one specific embodiment, the composition further comprises a coupling agent and a release agent. In the aforementioned embodiment, the surface of the magnetic powder is treated with a coupling agent, which can further enhance the oxidation resistance of the magnetic powder and improve the compatibility between the binder and the magnetic powder, isolating the binder from contact with the surface of the magnetic powder. Additionally, this treatment can increase the bonding strength between the surface of the magnetic powder and the polymer precursor. The addition of a release agent can reduce or prevent the adhesion of solid or liquid films on the surface of the magnet, preventing the magnetic powder, binder, and other materials from sticking to the surface of the equipment, thereby providing lubrication for the materials.

In further embodiments, the coupling agent is selected from one or more of siloxane coupling agents, titanate coupling agents, aluminate coupling agents, phosphate coupling agents, and organic iron coupling agents, and in some embodiments the coupling agent is selected from one or more of siloxane coupling agents, titanate coupling agents, aluminate coupling agents, and phosphate coupling agents.

The release agent is selected from one or more of organosilicon compounds, organofluorine compounds, natural waxes, synthetic waxes, metal salts of stearic acid, molybdenum disulfide, and fatty waxes, in some embodiments, including one or more of silicone oil, silicone rubber, silicone esters, silicone emulsifiers, natural waxes, synthetic waxes, zinc stearate, calcium stearate, molybdenum disulfide, lignite wax, Brazil wax, palm wax, paraffin, Fischer-Tropsch wax, and polyester films. More in some embodiments, the release agent comprises one or more of zinc stearate, silicone oil, paraffin, and palm wax.

In the composition, the content of the coupling agent is 0.28 to 0.30 wt %, and the content of the release agent is 0.3 to 0.5 wt %.

The third aspect of the present disclosure provides a method for preparing a bonded magnet using the composition described in the second aspect of the disclosure, which comprises:
mixing magnetic powder, polymer precursor, crosslinking agent, and catalyst to obtain a particle mixture;
forming the particle mixture into a compact, followed by curing the compact.

The bonded magnet prepared according to the method provided by the present disclosure possesses a dynamically cross-linked network structure. Within the magnet, exchangeable dynamic covalent bonds that form this structure can undergo cross-linking, de-chain, and re-cross-linking reactions under specific conditions. This allows the surfaces of the magnet to adhere to each other after being crushed, thereby enabling reformation of the magnet and resulting in a regenerated bonded magnet. Consequently, the bonded magnet provided by the present disclosure has an extremely high rate of recyclability. Furthermore, after multiple cycles of crushing and reformation, the magnet can still maintain the original molding density and exhibit high magnetic and mechanical performance.

In one specific embodiment, the method further includes: adding a solvent during the mixing process and stirring, while heating to remove the solvent during the stirring process, resulting in the particle mixture; the heating temperature being 10 to 50° C. higher than the boiling point of the solvent, in some embodiments, 10 to 20° C. higher, for a duration of 3 to 4 hours; the polymer precursor is selected from non-rubber polymer precursors. In this embodiment, by adding a solvent and heating during the stirring process to remove it, the rate of solvent evaporation is accelerated. This effectively enhances the flowability of the particle material mixture with high viscosity during the rapid removal of the solvent, allowing for effective mixing of magnetic powder with a high filling ratio and high molecular weight binder.

In one specific embodiment, the solvent is selected from one or more of deionized water, methanol, ethanol, isopropanol, n-butanol, isobutanol, tert-pentanol, ethyl ether, acetone, methyl ethyl ketone, diethyl ketone, methyl isobutyl ketone, tetrahydrofuran, chloroform, n-pentane, cyclopentane, cyclohexane, n-hexane, n-heptane, n-octane, N,N-dimethylformamide, N,N-dimethylacetamide, pyridine, benzene, toluene, xylene, isobutyl acetate, n-butyl acetate, sec-butyl acetate, ethyl acetate, isopropyl acetate, and n-propyl acetate. In some embodiments, the solvent is selected from one or more of tetrahydrofuran, acetone, and N,N-dimethylformamide.

In another specific embodiment, the method further includes: under heating conditions, feeding the magnetic powder, high molecular weight binder, crosslinking agent, and catalyst into an open mill for mixing treatment, thereby obtaining the particle material mixture; the polymer precursor is selected from rubber polymer precursors; the surface of the double rollers of the open mill is equipped with grooves or raised structures, with a gap between the double rollers of 1.5 to 2.0 mm. In this embodiment, by using an open mill with double rollers having grooves or raised structures, the magnetic powder and binder are mixed under heating conditions. For difficult-to-dissolve high molecular weight binders such as rubber, the grooves and raised structures effectively enhance the flowability of the mixture during the mixing process, allowing for thorough and uniform mixing of the high filler ratio magnetic powder with the difficult-to-dissolve high molecular weight binder. The heating conditions refer to temperatures sufficient to bring the high molecular weight binder into a molten or softened state.

In one specific embodiment, prior to the mixing process to obtain a particle mixture, the magnetic powder is pretreated with a coupling agent; in the mixing process, the particle material mixture additionally includes a release agent. In this embodiment, the use of a coupling agent to coat the surface of the magnetic powder can further enhance the oxidation resistance of the magnetic powder, improve the compatibility between the binder and the magnetic powder, and isolate the binder from direct contact with the surface of the magnetic powder. Additionally, this treatment can increase the bonding strength between the surface of the magnetic powder and the polymer precursor. The inclusion of a release agent can reduce or prevent the adhesion of solid or liquid films to the surface of the magnet, thereby preventing the magnetic powder, binder, and other materials from sticking to the equipment surface and providing lubrication for the materials.

In another specific embodiment, in the forming compact process, which employs either compression molding or calendering; the pressure during the forming process is between 5 to 10 MPa, in some embodiments, 6 to 8 MPa, with a temperature range of 25 to 100° C.; the curing treatment occurs at a temperature of 80 to 200° C., in some embodiments, 100 to 160° C., for a duration of 2 to 24 hours, in some embodiments, 3 to 4 hours.

The fourth aspect of the present disclosure provides a bonded magnet prepared by the method described in the third aspect of the disclosure.

The fifth aspect of the present disclosure provides a method for regenerating bonded magnets, wherein the regeneration method comprises: crushing the bonded magnets and then subjecting the resultant crushed material to a forming process, wherein the temperature of the forming process is above the dynamic crosslinking temperature of the vitrimer.

The present disclosure is further illustrated by the following examples, but is not limited thereby.

### Example 1

Based on the total weight of the composition, the composition used to prepare the bonded magnet in this example includes: 98 wt % magnetic powder, 0.885 wt % polymer precursor, 0.221 wt % crosslinking agent, 0.3 wt % catalyst, 0.294 wt % coupling agent, and 0.3 wt % release agent. The magnetic powder is selected from NdFeB 15-7 with a particle size of 59.6 μm, the polymer precursor is a bisphenol A type epoxy resin, the crosslinking agent is polyisocyanate, the catalyst is zinc acetate, the coupling agent is a silane coupling agent, and the release agent is zinc stearate.

Preparation process of the bonded magnet in the present disclosure is as follow.

Mixing the magnetic powder with the coupling agent and performing a coating treatment to obtain magnetic powder coated with the coupling agent.

Mixing the prepared polymer precursor, crosslinking agent, catalyst, and release agent with 200 g of solvent, then adding the magnetic powder to obtain a mixture, sending the mixture to a mixer for stirring, and raising the temperature of the mixture to 66° C. during the stirring process, and obtaining a particle material mixture after the solvent has completely evaporated; wherein the solvent is tetrahydrofuran and the stirring speed is 20-30 rpm.

Sending the particle material mixture to a press for compression molding treatment to obtain a compact, wherein the pressure during the forming process is 8 MPa and the mixture is held under pressure at room temperature for 10 minutes.

Placing the compact in an oven at 160° C. for curing treatment, with a curing time of 3 hours, resulting in the bonded magnet.

### Examples 2-11

Examples 2-11 refer to the preparation method in Example 1, with the difference being that the bonded magnets are prepared according to the compositions, molding temperatures, and curing temperatures listed in Table 1, while the remaining processes are the same as in Example 1.

### Example 12

Based on the total weight of the composition, the composition used in this example to prepare the bonded magnet includes: 96 wt % magnetic powder, 2.17 wt % polymer precursor, 0.542 wt % crosslinking agent, 0.5 wt % catalyst, 0.288 wt % coupling agent, and 0.5 wt % release agent. The magnetic powder is selected from NdFeB 16-10, the polymer precursor is polyurethane, the crosslinking agent is triethylamine, the catalyst is tin octoate, the coupling agent is a siloxane coupling agent, and the release agent is palm wax.

Preparation process of the bonded magnet in the present disclosure is as follow.

Mixing the magnetic powder with the coupling agent and performing a coating treatment to obtain magnetic powder coated with the coupling agent.

At 100° C., sending the magnetic powder, the polymer precursor, crosslinking agent, and catalyst into a two-roll mill for mixing treatment to obtain a particle material mixture; wherein the surface of the two rolls in the mill is equipped with grooves or protrusions.

Sending the particle material mixture to a press for calendering treatment to obtain a compact, wherein the gap between the two rolls is 1.5 to 2.0 mm.
Placing the compact in an oven at 120° C. for curing treatment, with a curing time of 4 hours, resulting in the bonded magnet.

### Examples 13-16, 21-22

Examples 13-16 and 21-22 refer to the preparation method in Example 1, with the difference being that the bonded magnets are prepared according to the compositions, molding temperatures, and curing temperatures listed in Table 1, while the remaining processes are the same as in Example 1.

### Examples 17-20

Examples 17-20 refer to the preparation method in Example 12, with the difference being that the bonded magnets are prepared according to the compositions, molding temperatures, and curing temperatures listed in Table 1, while the remaining processes are the same as in Example 12.

### Comparative Example 1

Based on the total weight of the composition, the composition used in this comparative example to prepare the bonded magnet includes: 98 wt % magnetic powder, 1.085 wt % binder, 0.121 wt % crosslinking agent, 0.294 wt % coupling agent, and 0.5 wt % release agent. The magnetic powder is selected from NdFeB 15-7, the binder is a bisphenol A type epoxy resin, the crosslinking agent is dicyandiamide, the coupling agent is a siloxane coupling agent, and the release agent is zinc stearate.

Preparation process of the bonded magnet in the present disclosure is as follow.

Mixing the magnetic powder with the coupling agent and performing a coating treatment to obtain magnetic powder coated with the coupling agent.

Dissolving the binder in 200 g of tetrahydrofuran and mixing it with the magnetic powder to obtain a mixture, then sending the mixture to a mixer for stirring to obtain a particle material mixture, wherein the stirring speed is 20-30 rpm and the stirring time is 0.5 hours.

Sending the particle material mixture to a press for compression molding to obtain a compact, wherein the molding pressure is 0.8 MPa and the pressing is maintained at room temperature for 10 minutes.

Placing the compact in an oven at 160° C. for curing treatment, with a curing time of 3 hours, resulting in the bonded magnet.

### Testing Examples

The bonded magnets from Examples 1-22 are tested as follows.

The magnetic properties of the original bonded magnets, the bonded magnets after one time of recycling, and the bonded magnets after two times of recycling are tested using a demagnetization curve testing instrument (model NIM-200C). The recycling method involves crushing; except for rubber and elastomer materials, which require cryogenic crushing, all other materials are processed at room temperature, resulting in recycled particle materials.

The heat distortion temperature and heat distortion behavior are tested using a thermomechanical analyzer (TMA). The humid heat aging testing method includes treating the bonded magnets in a humid heat oven at 60° C. and 90% humidity for 72 hours, followed by comparing the changes in magnetic moment before and after treatment.

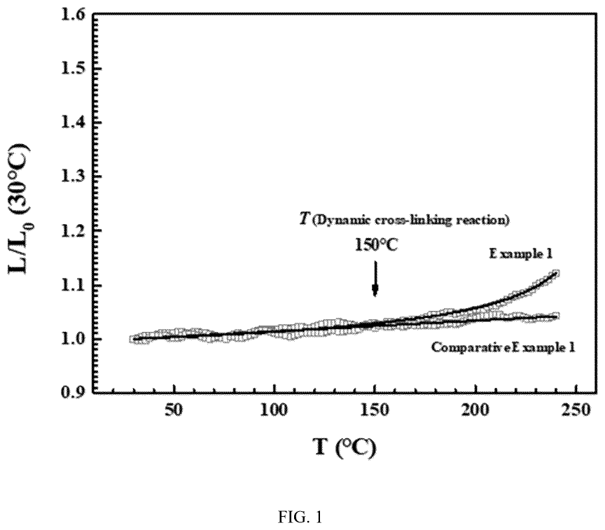

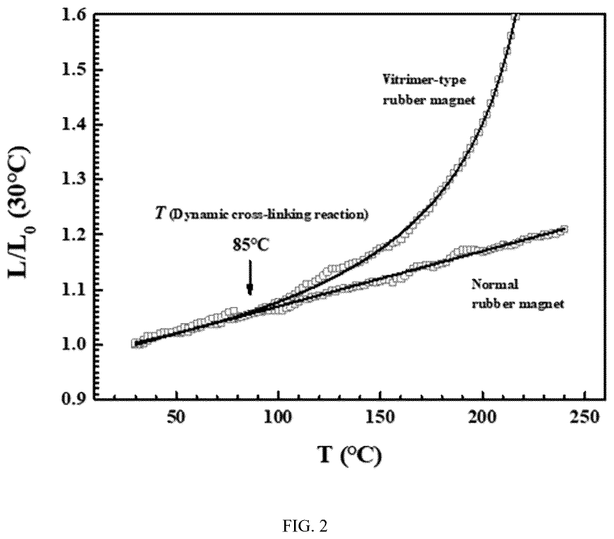

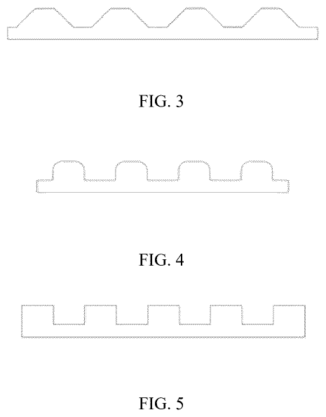

Tensile strength is tested using a universal tensile testing machine (model CTM2100). The results are presented in Tables 2, 3, and 4, with the heat distortion behavior results shown in FIGS. 1 and 2.

As shown in FIG. 1, the bonded magnets prepared in Example 1 exhibit an increasing linear thermal expansion coefficient with rising temperature above the dynamic crosslinking temperature (150° C.). In contrast, the linear thermal expansion coefficient of the bonded magnets prepared in Comparative Example 1 does not change with increasing temperature.

As shown in FIG. 2, the bonded magnets prepared in Example 12 (Vitrimer rubber magnets) also demonstrate an increasing linear thermal expansion coefficient with rising temperature above the dynamic crosslinking temperature (85° C.). In contrast, the linear thermal expansion coefficient of the bonded magnets prepared in Comparative Example 1 (normal rubber magnets) does not change with increasing temperature.

TABLE 1

| | Type and amount | | Type and amount | | Type and amount | | Type and amount | |
|---|---|---|---|---|---|---|---|---|
| | of polymer | | of crosslinking | | of magnetic | | of coupling | |
| | precursor (wt %) | | agent (wt %) | | powder (wt %) | | agent (wt %) | |
| Exam- | Bisphenol A | 0.885 | Phthalic | 0.221 | NdFeB | 98 | Silane | 0.294 |
| ple 1 | type epoxy | | anhydride | | 15-7 | | coupling | |
| | resin | | | | | | agent | |
| Exam- | Bisphenol A | 0.885 | Phthalic | 0.221 | NdFeB | 98 | Titanate | 0.294 |
| ple 2 | type epoxy | | anhydride | | 15-7 | | coupling | |
| | resin | | | | | | agent | |
| Exam- | Bisphenol A | 0.885 | Phthalic | 0.221 | NdFeB | 98 | Aluminate | 0.294 |
| ple 3 | type epoxy | | anhydride | | 15-7 | | coupling | |
| | resin | | | | | | agent | |
| Exam- | Bisphenol A | 0.885 | Phthalic | 0.221 | NdFeB | 98 | Phosphate | 0.294 |
| ple 4 | type epoxy | | anhydride | | 15-7 | | ester | |
| | resin | | | | | | coupling | |
| | | | | | | | agent | |
| Exam- | Bisphenol A | 2.17 | Phthalic | 0.542 | Isotropic | 96 | Phosphate | 0.288 |
| ple 5 | type epoxy | | anhydride | | SmFeN | | ester | |
| | resin | | | | | | coupling | |
| | | | | | | | agent | |
| Exam- | Bisphenol A | 2.17 | Phthalic | 0.542 | Anisotropic | 96 | Phosphate | 0.288 |
| ple 6 | type epoxy | | anhydride | | SmFeN | | ester | |
| | resin | | | | | | coupling | |
| | | | | | | | agent | |
| Exam- | Bisphenol A | 2.17 | Phthalic | 0.542 | Ferrite | 96 | Silane | 0.288 |
| ple 7 | type epoxy | | anhydride | | | | coupling | |
| | resin | | | | | | agent | |
| Exam- | Bisphenol A | 0.885 | Phthalic | 0.221 | SmCo | 98 | Phosphate | 0.294 |
| ple 8 | type epoxy | | anhydride | | | | ester | |
| | resin | | | | | | coupling | |
| | | | | | | | agent | |
| Exam- | Phenol- | 0.885 | Glycerol | 0.221 | NdFeB | 98 | Silane | 0.294 |
| ple 9 | formal- | | | | 14-12 | | coupling | |
| | dehyde | | | | | | agent | |
| | resin | | | | | | | |
| Exam- | Poly(methyl | 2.17 | Glycerol | 0.542 | NdFeB | 96 | Silane | 0.288 |
| ple 10 | methac- | | | | 14-12 | | coupling | |
| | rylate) | | | | | | agent | |
| Exam- | Polyurethane | 2.17 | Polyeth- | 0.542 | NdFeB | 96 | Silane | 0.288 |
| ple 11 | | | ylene | | 16-10 | | coupling | |
| | | | glycol | | | | agent | |
| Exam- | Polyurethane | 2.17 | Trietha- | 0.542 | NdFeB | 96 | Silane | 0.288 |
| ple 12 | | | nolamine | | 16-10 | | coupling | |
| | | | | | | | agent | |
| Exam- | Polybutylene | 2.17 | Glycerol | 0.542 | NdFeB | 96 | Silane | 0.288 |
| ple 13 | terephthalate | | | | 14-12 | | coupling | |
| | | | | | | | agent | |
| Exam- | Polybutylene | 0.885 | Glycerol | 0.221 | NdFeB | 98 | Silane | 0.294 |
| ple 14 | terephthalate | | | | 14-12 | | coupling | |
| | | | | | | | agent | |
| Exam- | Polybutylene | 0.885 | Glycerol | 0.221 | NdFeB | 98 | Silane | 0.294 |
| ple 15 | terephthalate | | | | 14-12 | | coupling | |
| | | | | | | | agent | |
| Exam- | Polycar- | 2.17 | Penta- | 0.542 | NdFeB | 96 | Silane | 0.288 |
| ple 16 | bonate | | erythritol | | 14-12 | | coupling | |
| | | | | | | | agent | |
| Exam- | Nitrile | 2.17 | Penta- | 0.542 | NdFeB | 96 | Silane | 0.288 |
| ple 17 | rubber | | erythritol | | 16-10 | | coupling | |
| | | | | | | | agent | |
| Exam- | Terpolymer | 2.17 | Penta- | 0.542 | NdFeB | 96 | Silane | 0.288 |
| ple 18 | of ethylene, | | erythritol | | 16-10 | | coupling | |
| | propylene, | | | | | | agent | |
| | and diene | | | | | | | |
| Exam- | Thermo- | 2.17 | Penta- | 0.542 | NdFeB | 96 | Silane | 0.288 |
| ple 19 | plastic | | erythritol | | 16-10 | | coupling | |
| | polyester | | | | | | agent | |
| | elastomer | | | | | | | |
| Exam- | Thermo- | 2.17 | Penta- | 0.542 | NdFeN | 96 | Silane | 0.288 |
| ple 20 | plastic | | erythritol | | | | coupling | |
| | polyester | | | | | | agent | |
| | elastomer | | | | | | | |
| Exam- | Polyamide | 0.885 | Diethylene | 0.221 | NdFeB | 98 | Titanate | 0.294 |
| ple 21 | | | triamine | | 14-12 | | coupling | |
| | | | | | | | agent | |
| Exam- | Poly(4- | 2.17 | 1,4- | 0.542 | NdFeB | 96 | Silane | 0.288 |
| ple 22 | vinyl- | | Dibromo- | | 14-12 | | coupling | |
| | pyridine) | | butane | | | | agent | |
| Con- | Bisphenol A | 1.085 | Melamine | 0.121 | NdFeB | 98 | Silane | 0.294 |
| trol 1 | type epoxy | | formal- | | 15-7 | | coupling | |
| | resin | | dehyde | | | | agent | |

| | | | | | | | Molding | Curing |
|---|---|---|---|---|---|---|---|---|
| | Type and amount | | Type and amount | | Type and amount | | temper- | temper- |
| | of catalyst | | of release | | of solvent | | ature | ature |
| | (wt %) | | agent (wt %) | | (g) | | (° C.) | (° C.) |
| Exam- | Zinc | 0.3 | Zinc | 0.3 | THF | 200 | 25 | 160 |
| ple 1 | acetate | | stearate | | | | | |
| Exam- | Zinc | 0.3 | Zinc | 0.3 | THF | 200 | 25 | 160 |
| ple 2 | acetate | | stearate | | | | | |
| Exam- | Zinc | 0.3 | Zinc | 0.3 | THF | 200 | 25 | 160 |
| ple 3 | acetate | | stearate | | | | | |
| Exam- | Zinc | 0.3 | Zinc | 0.3 | THF | 200 | 25 | 160 |
| ple 4 | acetate | | stearate | | | | | |
| Exam- | Zinc | 0.5 | Zinc | 0.5 | THF | 400 | 25 | 160 |
| ple 5 | acetate | | stearate | | | | | |
| Exam- | Zinc | 0.5 | Zinc | 0.5 | THF | 400 | 25 | 160 |
| ple 6 | acetate | | stearate | | | | | |
| Exam- | Zinc | 0.5 | Zinc | 0.5 | THF | 400 | 25 | 160 |
| ple 7 | acetate | | stearate | | | | | |
| Exam- | Zinc | 0.3 | Zinc | 0.3 | THF | 200 | 25 | 160 |
| ple 8 | acetate | | stearate | | | | | |
| Exam- | Zinc | 0.3 | Zinc | 0.3 | THF | 200 | 25 | 180 |
| ple 9 | acetate | | stearate | | | | | |
| Exam- | Zinc | 0.5 | Silicone | 0.5 | THF | 400 | 25 | 140 |
| ple 10 | acetate | | oil | | | | | |
| Exam- | Tin(II) | 0.5 | Calcium | 0.5 | THF | 400 | 25 | 120 |
| ple 11 | ethyl- | | stearate | | | | | |
| | hexanolate | | | | | | | |
| Exam- | Tin(II) | 0.5 | Carnauba | 0.5 | / | / | 100 | 120 |
| ple 12 | ethyl- | | wax | | | | | |
| | hexanoate | | | | | | | |
| Exam- | Zinc | 0.5 | Carnauba | 0.5 | THF | 400 | 25 | 140 |
| ple 13 | acetate | | wax | | | | | |
| Exam- | 1,2,3- | 0.3 | Zinc | 0.3 | THF | 200 | 25 | 140 |
| ple 14 | Propanetri- | | stearate | | | | | |
| | carboxylic | | | | | | | |
| | acid, | | | | | | | |
| | 2-sulfo-, | | | | | | | |
| | 1,2-dimethyl | | | | | | | |
| | ester, | | | | | | | |
| | sodium salt | | | | | | | |
| Exam- | Triphenyl- | 0.3 | Calcium | 0.3 | THF | 200 | 25 | 140 |
| ple 15 | phosphine | | stearate | | | | | |
| Exam- | Tin(II) | 0.5 | Zinc | 0.5 | Acetone | 200 | 25 | 150 |
| ple 16 | ethyl- | | stearate | | | | | |
| | hexanoate | | | | | | | |
| Exam- | Zinc | 0.5 | Carnauba | 0.5 | / | / | 80 | 100 |
| ple 17 | acetate | | wax | | | | | |
| Exam- | Zinc | 0.5 | Carnauba | 0.5 | / | / | 80 | 100 |
| ple 18 | acetate | | wax | | | | | |
| Exam- | Zinc | 0.5 | Carnauba | 0.5 | / | / | 100 | 110 |
| ple 19 | acetate | | wax | | | | | |
| Exam- | Tin(II) | 0.5 | Paraffin | 0.5 | / | / | 100 | 130 |
| ple 20 | ethyl- | | wax | | | | | |
| | hexanoate | | | | | | | |
| Exam- | Tin(II) | 0.3 | Zinc | 0.3 | Acetone | 200 | 25 | 140 |
| ple 21 | ethyl- | | stearate | | | | | |
| | hexanoate | | | | | | | |
| Exam- | Zinc | 0.5 | Zinc | 0.5 | N,N- | 400 | 25 | 140 |
| ple 22 | acetate | | stearate | | Dimethyl | | | |
| | | | | | formamide | | | |
| Con- | — | — | Zinc | 0.5 | THF | 200 | 25 | 160 |
| trol 1 | | | stearate | | | | | |

TABLE 2

| | | | | | Maximum | | | |
|---|---|---|---|---|---|---|---|---|
| | | | | | Energy | | | Heat |
| | | | | Intrinsic | Product | Wet High | Tensile | Distortion |
| | Density | Remanence | Coercivity | Coercivity | ((BH)max) | Reduction | Strength | Temperature |
| | (g/cm3) | (Gs) | (Oe) | (Oe) | (MGOe) | (%) | (MPa) | (° C.) |
| Example 1 | 6.10 | 7375 | 5066 | 7023 | 10.03 | −5.14 | 8.31 | 151 |
| Example 2 | 6.08 | 7259 | 4972 | 6873 | 9.89 | −4.87 | 7.65 | 155 |
| Example 3 | 6.07 | 7182 | 4987 | 6905 | 9.66 | −5.23 | 8.03 | 159 |
| Example 4 | 6.12 | 7389 | 5077 | 7009 | 10.07 | −5.01 | 8.57 | 157 |
| Example 5 | 5.69 | 5175 | 4045 | 10397 | 5.23 | −3.54 | 11.40 | 150 |
| Example 6 | 5.32 | 7794 | 6107 | 10122 | 13.55 | −3.21 | 12.16 | 149 |
| Example 7 | 3.97 | 3181 | 2466 | 2610 | 2.03 | −0.88 | 11.89 | 158 |
| Example 8 | 6.98 | 7782 | 6364 | 11234 | 12.54 | −4.86 | 15.66 | 152 |
| Example 9 | 6.11 | 6680 | 5540 | 11787 | 9.41 | −4.78 | 12.04 | 177 |
| Example 10 | 5.79 | 6345 | 5211 | 11587 | 8.12 | −4.34 | 6.32 | 139 |
| Example 11 | 5.82 | 6887 | 5602 | 9283 | 9.51 | −2.34 | 4.98 | 116 |
| Example 12 | 5.83 | 6721 | 5598 | 9302 | 9.40 | −2.21 | 4.35 | 108 |
| Example 13 | 5.84 | 6324 | 5198 | 11365 | 8.11 | −4.43 | 5.66 | 137 |
| Example 14 | 6.11 | 6589 | 5431 | 11688 | 9.06 | −5.01 | 6.15 | 141 |
| Example 15 | 6.15 | 6741 | 5609 | 11884 | 9.52 | −4.76 | 6.78 | 134 |
| Example 16 | 5.75 | 6278 | 5146 | 11406 | 8.01 | −6.04 | 6.24 | 146 |
| Example 17 | 5.92 | 7201 | 5866 | 9433 | 10.24 | −7.12 | 1.55 | 98 |
| Example 18 | 5.89 | 7176 | 5800 | 9428 | 10.52 | −7.65 | 1.02 | 85 |
| Example 19 | 5.85 | 7110 | 5988 | 9506 | 9.82 | −1.23 | 5.33 | 112 |
| Example 20 | 5.88 | 7345 | 5743 | 5765 | 10.17 | −2.46 | 2.24 | 134 |
| Example 21 | 6.13 | 6718 | 5548 | 11836 | 9.54 | −2.87 | 4.45 | 130 |
| Example 22 | 5.74 | 6199 | 5178 | 11588 | 8.18 | −7.98 | 5.34 | 128 |
| Compar- | 6.12 | 7402 | 5052 | 7011 | 9.94 | −4.87 | 7.88 | N/A |
| ative 1 | | | | | | | | |

TABLE 3

| | | | | | | | | | Tensile | Heat |
|---|---|---|---|---|---|---|---|---|---|---|
| | | | | | | | Moisture | Tensile | strength-1/ | distortion |
| | Density | Br | Hcb | Hcj | (BH)max-1 | (BH)max-1/ | resistance | strength-1 | Tensile | temperature |
| | (g/cm3) | (Gs) | (Oe) | (Oe) | (MGOe) | (BH)max | (%) | (MPa) | strength | (° C.) |
| Example 1 | 6.09 | 7223 | 4913 | 6888 | 9.67 | 0.964 | −5.16 | 8.18 | 0.984 | 149 |
| Example 2 | 6.08 | 7128 | 4901 | 6703 | 9.45 | 0.956 | −5.03 | 7.54 | 0.986 | 151 |
| Example 3 | 6.03 | 7041 | 4863 | 6785 | 9.24 | 0.957 | −5.23 | 7.89 | 0.983 | 156 |
| Example 4 | 6.13 | 7261 | 4953 | 6875 | 9.58 | 0.951 | −4.98 | 8.38 | 0.978 | 150 |
| Example 5 | 5.67 | 5046 | 3988 | 9633 | 4.98 | 0.952 | −3.46 | 11.11 | 0.975 | 150 |
| Example 6 | 5.34 | 7685 | 6022 | 9408 | 12.91 | 0.953 | −3.35 | 11.88 | 0.977 | 151 |
| Example 7 | 3.95 | 3106 | 2405 | 2621 | 1.92 | 0.946 | −0.97 | 11.65 | 0.980 | 154 |
| Example 8 | 6.99 | 7602 | 6161 | 11167 | 11.89 | 0.948 | −4.97 | 15.27 | 0.975 | 149 |
| Example 9 | 6.09 | 6584 | 5412 | 11604 | 9.09 | 0.966 | −4.99 | 11.87 | 0.986 | 172 |
| Example 10 | 5.76 | 6223 | 5124 | 11473 | 7.91 | 0.974 | −4.65 | 6.24 | 0.987 | 133 |
| Example 11 | 5.83 | 6695 | 5501 | 9166 | 9.27 | 0.975 | −2.22 | 4.68 | 0.940 | 111 |
| Example 12 | 5.83 | 6578 | 5307 | 9172 | 8.99 | 0.956 | −2.21 | 4.11 | 0.945 | 112 |
| Example 13 | 5.80 | 6209 | 5043 | 11194 | 7.79 | 0.961 | −5.00 | 5.48 | 0.968 | 135 |
| Example 14 | 6.10 | 6422 | 5287 | 11456 | 8.68 | 0.958 | −5.23 | 5.99 | 0.974 | 138 |
| Example 15 | 6.13 | 6594 | 5444 | 11684 | 9.32 | 0.979 | −4.88 | 6.54 | 0.965 | 132 |
| Example 16 | 5.77 | 6156 | 5004 | 11267 | 7.83 | 0.978 | −5.43 | 6.03 | 0.966 | 144 |
| Example 17 | 5.90 | 7086 | 5766 | 9356 | 10.00 | 0.977 | −7.12 | 1.47 | 0.948 | 86 |
| Example 18 | 5.88 | 7003 | 5655 | 9383 | 10.22 | 0.971 | −7.45 | 0.96 | 0.941 | 85 |
| Example 19 | 5.82 | 6900 | 5541 | 9399 | 9.64 | 0.982 | −1.38 | 5.07 | 0.951 | 110 |
| Example 20 | 5.88 | 7111 | 5534 | 5567 | 9.96 | 0.979 | −2.57 | 2.01 | 0.897 | 130 |
| Example 21 | 6.14 | 6622 | 5402 | 11663 | 9.33 | 0.978 | −2.76 | 4.38 | 0.984 | 133 |
| Example 22 | 5.67 | 6041 | 5000 | 11444 | 8.03 | 0.982 | −8.01 | 5.20 | 0.974 | 131 |

| | |
|---|---|
| Comparative | Unable to mold again |
| Example 1 | |

TABLE 4

| | | | | | | | | | Tensile | Heat |
|---|---|---|---|---|---|---|---|---|---|---|
| | | | | | | | | Tensile | Strength-2/ | Deflection |
| | Density | Br | Hcb | Hcj | (BH)max-2 | (BH)max-2/ | Hygrothermal | Strength-2 | Tensile | Temperature |
| | (g/cm3) | (Gs) | (Oe) | (Oe) | (MGOe) | BHmax | Aging (%) | (MPa) | Strength | (° C.) |
| Example 1 | 6.08 | 7084 | 4786 | 6754 | 9.02 | 0.899 | −5.07 | 7.98 | 0.960 | 146 |
| Example 2 | 6.05 | 7011 | 4734 | 6623 | 8.82 | 0.892 | −5.13 | 7.33 | 0.958 | 153 |
| Example 3 | 6.04 | 6922 | 4700 | 6687 | 8.54 | 0.884 | −5.42 | 7.68 | 0.956 | 155 |
| Example 4 | 6.06 | 7037 | 4795 | 6767 | 9.03 | 0.897 | −5.24 | 8.20 | 0.957 | 151 |
| Example 5 | 5.64 | 4922 | 3844 | 9588 | 4.77 | 0.912 | −3.28 | 10.96 | 0.961 | 149 |
| Example 6 | 5.28 | 7444 | 5843 | 9378 | 12.17 | 0.898 | −3.33 | 11.65 | 0.958 | 156 |
| Example 7 | 3.95 | 3100 | 2413 | 2598 | 1.95 | 0.961 | −1.02 | 11.44 | 0.962 | 153 |
| Example 8 | 6.97 | 7435 | 6056 | 11099 | 11.22 | 0.895 | −5.01 | 15.11 | 0.965 | 154 |
| Example 9 | 6.09 | 6433 | 5207 | 11554 | 8.42 | 0.895 | −5.01 | 11.67 | 0.969 | 168 |
| Example 10 | 5.75 | 6088 | 5000 | 11373 | 7.41 | 0.913 | −4.76 | 6.05 | 0.957 | 132 |
| Example 11 | 5.80 | 6512 | 5298 | 9087 | 8.43 | 0.886 | −2.15 | 4.49 | 0.902 | 114 |
| Example 12 | 5.80 | 6374 | 5120 | 9023 | 8.01 | 0.852 | −2.19 | 3.87 | 0.890 | 114 |
| Example 13 | 5.81 | 6077 | 4876 | 11055 | 7.36 | 0.908 | −4.97 | 5.33 | 0.942 | 134 |
| Example 14 | 6.10 | 6324 | 5094 | 11387 | 8.05 | 0.889 | −5.33 | 5.84 | 0.950 | 137 |
| Example 15 | 6.13 | 6409 | 5267 | 11596 | 8.42 | 0.884 | −4.89 | 6.39 | 0.942 | 132 |
| Example 16 | 5.74 | 6008 | 4855 | 11168 | 7.21 | 0.900 | −5.43 | 5.87 | 0.941 | 145 |
| Example 17 | 5.90 | 6897 | 5478 | 9254 | 9.32 | 0.910 | −7.18 | 1.38 | 0.890 | 87 |
| Example 18 | 5.86 | 6879 | 5523 | 9292 | 9.49 | 0.902 | −7.34 | 0.92 | 0.902 | 85 |
| Example 19 | 5.82 | 6784 | 5266 | 9281 | 8.86 | 0.902 | −1.29 | 4.98 | 0.934 | 111 |
| Example 20 | 5.82 | 6907 | 5287 | 5480 | 9.11 | 0.896 | −2.65 | 1.99 | 0.888 | 132 |
| Example 21 | 6.10 | 6473 | 5222 | 11500 | 8.63 | 0.905 | −2.83 | 4.23 | 0.951 | 132 |
| Example 22 | 5.70 | 5892 | 4793 | 11367 | 7.26 | 0.888 | −8.04 | 5.07 | 0.949 | 131 |

| | |
|---|---|
| Compar- | Cannot be remolded |
| ison 1 | |

From Tables 2 to 4, it can be seen that the present disclosure uses a polymer system that can form a dynamic covalent crosslinking network as the binder for bonding magnets. This allows the bonded magnets provided by the present disclosure to have a dynamic crosslinking network structure. The exchangeable dynamic covalent bonds within the magnet can undergo crosslinking-breaking-crosslinking dynamic crosslinking reactions under specific conditions, allowing the magnet's surface to adhere to each other after being broken, thereby achieving magnet reshaping and obtaining regenerated bonded magnets. As shown in Examples 1 to 22, the bonded magnets provided by the present disclosure have a high recyclability rate, possess reversible processability, and are non-melting. Crushing and reshaping the original product can achieve 100% recyclability. Compared to the original bonded magnets, the density remains almost unchanged, with a maximum energy product (BH) max-1 being 95-98% of the original bonded magnets (BH) max, the wet hot reduction remains almost unchanged, and the tensile strength is 90 to 98% of the original bonded magnets. After being recycled twice, the bonded magnets can still maintain the original magnet's density, with a maximum energy product (BH) max-2 being 89 to 91% of the original bonded magnets (BH) max, the wet hot reduction remaining almost unchanged, and the tensile strength being 89 to 96% of the original bonded magnets. Therefore, bonded magnets prepared using the method of the present disclosure can maintain the original magnet's density, high magnetic and mechanical properties even after multiple crushing and reshaping.

From the examples 1-11, 13-16, 21, and 22, it can be seen that by adopting the methods of solution blending or melt blending, the high filler ratio magnetic powder can be effectively mixed uniformly with the binder. In solution blending, the high filler ratio magnetic powder can be effectively mixed with high molecular weight binders by adding solvents and heating to remove the solvents during the stirring process, which improves the flowability of the mixture quickly by removing the solvent, thereby further enhancing the regeneration performance of the magnet. This enables the bonded magnet to have a very high recyclability rate, as well as maintaining the original molding density and high moisture and heat reduction after crushing and reshaping, while still maintaining high magnetic and mechanical properties.

Examples 12, 17-20 reveals that using melt blending involves mixing magnetic powder with a high filling ratio and a hard-to-dissolve high molecular weight binding agent, such as rubber, at high temperatures in an open mill with double rolls that have grooves or protrusions. This process ensures thorough and uniform blending, further enhancing the regeneration performance of the magnet. This results in bonded magnets with a very high recyclability rate, allowing the crushed and reshaped magnets to maintain their original density, thermal and moisture resistance, as well as high magnetic and mechanical performance.

When comparing Comparative Example 1 with Examples 1-22, it is noted that the binder used in Comparative Example 1 is a conventional epoxy resin, which results in the bonded magnets produced lacking regeneration capability. Consequently, after multiple cycles of crushing, reshaping cannot be achieved.

Some embodiments of the present disclosure have been described in detail above in conjunction with the accompanying drawings. However, the present disclosure is not limited to the specific details of the above embodiments, and within the technical scope of the present disclosure, various simple modifications can be made to the technical solutions of the present disclosure, all of which fall within the scope of protection of the present disclosure.

The specific technical features described in the above-mentioned specific implementation methods can be combined in any appropriate manner, as long as they are not contradictory. In order to avoid unnecessary repetitions, this disclosure does not separately explain all possible combinations.

In addition, various different embodiments of the present disclosure can also be combined in any manner, as long as they do not depart from the spirit of the present disclosure, they should also be considered as the content disclosed by the present disclosure.

1. A bonded magnet comprising:
magnetic powder; and
a binder including a vitrimer;
wherein a content of the magnetic powder ranges from 96 wt % to 98 wt % and a content of the binder ranges from 0.89 wt % to 2.17 wt %.

2. The bonded magnet according to claim 1, wherein:
the vitrimer includes a temperature-responsive vitrimer with a dynamic crosslinking temperature ranging from 85° C. to 177° C., and a linear thermal expansion coefficient of the bonded magnet increases with temperature above the dynamic crosslinking temperature.

3. The bonded magnet according to claim 2, wherein:
the vitrimer is selected from the group consisting of: ester-exchange vitrimers, ether-exchange vitrimers, alkylation-dealkylation vitrimers, transcarbonation vitrimers, hydroxy-urethane bond-exchange vitrimers, urethane-urethane bond-exchange vitrimers, disulfide bond-exchange vitrimers, silanol-exchange vitrimers, olefin metathesis vitrimers, imine-exchange vitrimers, and acylhydrazone bond-exchange vitrimers, or combinations thereof.

4. The bonded magnet according to claim 1, wherein:
a polymer precursor of the vitrimer is selected from thermosetting resins, thermoplastic resins, thermoplastic elastomers, and rubbers, or combinations thereof.

5. The bonded magnet according to claim 4, wherein:
the polymer precursor is selected from the group consisting of: polyimide, polyamide, polyester, polyether, polyoxymethylene, polycarbonate, polymethyl methacrylate, polyethyl methacrylate, polybutyl methacrylate, polybutylene terephthalate, polystyrene, poly(4-vinylpyridine), polylactic acid, chitosan, cellulose and derivatives thereof, polyurethane, thermoplastic polyester elastomer, acrylate copolymer, epoxy resin, phenolic resin, urea-formaldehyde resin, polyvinyl alcohol, polyvinyl butyral, polyvinyl acetate, polyether ether ketone, natural rubber, nitrile rubber, butyl rubber, ethylene-propylene rubber, ethylene-propylene-diene rubber, cis-polybutadiene rubber, silicone rubber, fluororubber, ethylene-vinyl acetate copolymer, acrylonitrile-butadiene-styrene copolymer, and styrene-butadiene-styrene copolymer, or combinations thereof.

6. The bonded magnet according to claim 1, wherein:
the magnetic powder is selected from the group consisting of: NdFeB magnetic powder, SmFeN magnetic powder, NdFeN magnetic powder, SmCo magnetic powder, ferrite powder, AlNiCo magnetic powder, FeCo magnetic powder, FeSiAl magnetic powder, and FeSi magnetic powder. the magnetic powder is selected from NdFeB, SmFeN, NdFeN, SmCo, ferrite, AlNiCo, FeCo, FeSiAl, and FeSi magnetic powders.

7. A composition for preparing bonded magnets, comprising:
magnetic powder;
a polymer precursor;
a crosslinking agent; and
a catalyst capable of catalyzing a crosslinking reaction between the crosslinking agent and the polymer precursor to form a dynamically crosslinked network structure.

8. The composition according to claim 7, wherein:
the magnetic powder is selected from the group consisting of: NdFeB magnetic powder, SmFeN magnetic powder, NdFeN magnetic powder, SmCo magnetic powder, ferrite powder, AlNiCo magnetic powder, FeCo magnetic powder, FeSiAl magnetic powder, and FeSi magnetic powder, with a particle size ranging from 2 μm to 150 μm.

9. The composition according to claim 7, wherein:
the polymer precursor is selected from the group consisting of: polyimide, polyamide, polyester, polyether, polyoxymethylene, polycarbonate, polymethyl methacrylate, polyethyl methacrylate, polybutyl methacrylate, polybutylene terephthalate, polystyrene, poly(4-vinylpyridine), polylactic acid, chitosan, cellulose and derivatives thereof, polyurethane, thermoplastic polyester elastomer, acrylate copolymer, epoxy resin, phenolic resin, urea-formaldehyde resin, polyvinyl alcohol, polyvinyl butyral, polyvinyl acetate, polyether ether ketone, natural rubber, nitrile rubber, butyl rubber, ethylene-propylene rubber, ethylene-propylene-diene rubber, cis-polybutadiene rubber, silicone rubber, fluororubber, ethylene-vinyl acetate copolymer, acrylonitrile-butadiene-styrene copolymer, and styrene-butadiene-styrene copolymer, or combinations thereof.

10. The composition according to claim 7, wherein:
the crosslinking agent is selected from multifunctional halogenated hydrocarbons or active hydrogen-containing compounds.

11. The composition according to claim 10, wherein:
the crosslinking agent is selected from one or more of dihalogenated hydrocarbons, polyhalogenated hydrocarbons, diethylamine, triethylamine, polyamines, 1,4-butanediol, isopentyl glycol, pentaerythritol, glycerol, polyols, diphenols, polyphenols, dithiols, polythiols, amides, diureas, polyureas, diisocyanates, polyisocyanates, maleic anhydride derivatives, phthalate derivatives, oxalic acid, diacids, polyacids, polytetrahydrofuran, polyethylene glycol, polyvinyl alcohol, macromolecular diols, telechelic polyols, linear telechelic polymers with hydroxyl, thiol, amino, carboxyl, epoxy, formate, or acetate groups, star polymers, and hyperbranched polymers.

12. The composition according to claim 7, wherein:
the catalyst is selected from organic zinc salts.

13. The composition according to claim 12, wherein:
the catalyst is selected from zinc acetate, 1,5,7-triazabicyclo[4.4.0]dec-5-ene, triphenylphosphine, or stannous octoate, or combinations thereof.

14. The composition according to claim 7, wherein:
the composition contains 96 wt % to 98 wt % magnetic powder, 0.88 wt % to 2.17 wt % polymer precursor, 0.22 wt % to 0.55 wt % crosslinking agent, and 0.3 wt % to 0.5 wt % catalyst.

15. The composition according to claim 7, further comprising:
a coupling agent selected from silane coupling agents, titanate coupling agents, aluminate coupling agents, phosphate coupling agents, or organoiron coupling agents; and
a release agent selected from silicone-based agents, fluorine-based agents, natural waxes, synthetic waxes, molybdenum disulfide, fatty waxes, or polyester films;
wherein the composition contains 0.28-0.30 wt % coupling agent and 0.30-0.50 wt % release agent.

16. A method for preparing adhesive magnets using the composition of claim 7, comprising:
mixing the magnetic powder, the polymer precursor, the crosslinking agent, and the catalyst to obtain a particle mixture;
forming the particle mixture into a compact; and
curing the compact.

17. The method according to claim 16, further comprising:
adding a solvent during the mixing process and stirring, while heating to remove the solvent during the stirring process at a heating temperature of 10° C. to 50° C. higher than a boiling point of the solvent and for a duration of 3 hours to 4 hours, resulting in the particle mixture;
wherein the solvent is selected from one or more of deionized water, methanol, ethanol, isopropanol, n-butanol, isobutanol, tert-pentanol, ethyl ether, acetone, methyl ethyl ketone, diethyl ketone, methyl isobutyl ketone, tetrahydrofuran, chloroform, n-pentane, cyclopentane, cyclohexane, n-hexane, n-heptane, n-octane, N,N-dimethylformamide, N,N-dimethylacetamide, pyridine, benzene, toluene, xylene, isobutyl acetate, n-butyl acetate, sec-butyl acetate, ethyl acetate, isopropyl acetate, and n-propyl acetate.

18. The method according to claim 16, further comprising:
under heating conditions, feeding the magnetic powder, the polymer precursor, the crosslinking agent, and the catalyst into an open mill for mixing treatment to obtain the particle mixture;
wherein surfaces of double rollers of the open mill are provided with grooves or raised structures.

19. The method according to claim 16, further comprising:
pretreating the magnetic powder with a coupling agent prior to the mixing process;
wherein:
the particle mixture further includes a release agent;
the process of forming the compact includes compression molding or rolling molding, and a pressure during the forming process is 5 MPa to 10 MPa and a temperature during the forming process is 25° C. to 100° C.;
the process of curing the compact is conducted at a temperature of 80° C. to 200° C. for a duration of 2 hours to 24 hours.
